(19) United States
(12) Patent Application Publication
(10) Pub. No.: US 2026/0310543 A1
(43) Pub. Date: Oct. 8, 2026

(54) Managing Resource Usage Monitoring Using Machine Learning and Rules-Based Models

(71) Applicant: Oracle International Corporation, Redwood Shores, CA (US)

(72) Inventors: Lawrence Jackson Nelson, III, Kingwood, TX (US); Timothy James McAuliffe, Middletown, CT (US); Jason James Duncan-Wilson, Cincinnati, OH (US); Alfred J Bresnahan, Marblehead, MA (US)

(73) Assignee: Oracle International Corporation, Redwood Shores, CA (US)

(21) Appl. No.: 19/234,859

(22) Filed: Jun. 11, 2025

Related U.S. Application Data
(60) Provisional application No. 63/783,901, filed on Apr. 4, 2025.

(51) Int. Cl. G06F 11/07; G06F 9/50; G06F 11/30

(52) U.S. Cl. CPC G06F 11/0793; G06F 9/5005; G06F 11/3051

(57) ABSTRACT

Techniques for improving the performance of a resource usage monitoring system by selectively verifying anomaly predictions are disclosed. A system inputs resource usage data to a machine learning model. The system determines remediation actions to perform based on whether or not the system verifies machine-learning-generated anomaly predictions. The system verifies the anomaly predictions by applying measured resource usage data to a rules-based verification model. If the system verifies a predicted anomaly, the system remediates faults in resource metering devices, such as sensors, memory chips, microcontrollers, and data transmission devices. If the system determines a predicted anomaly is not verified, the system remediates a fault in the machine learning model by generating a training record based on the measured and estimated resource usage values to retrain the machine learning model.

### BENEFIT CLAIMS; RELATED APPLICATIONS; INCORPORATION BY REFERENCE

This application claims the benefit of U.S. Provisional Patent Application 63/783,901, filed Apr. 4, 2025, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to monitoring resource usage. In particular, the present disclosure relates to detecting anomalous monitoring data and remediating components in a monitoring system that contributes to the anomalies.

### BACKGROUND

Remote system monitoring platforms monitor system characteristics in real time from sensors and analyze the sensor data to identify problems that may arise in the systems. One remote system monitoring platform is advanced metering infrastructure (AMI). AMI monitors an entity’s utility usage using a utility meter. A transmitter transmits utility usage data to a utility provider. For example, a home equipped with an AMI power meter transmits power data to a power utility provider in real time or at regular intervals. The utility provider collects usage data for a particular time period to bill customers for their utility usage. In addition, utility providers may analyze usage data to identify usage requirements for customers and regions. Anomalies may occur in an AMI system as a result of theft, cyber-attacks, meter malfunctions, appliance or device malfunctions, data corruption, or other problems. Inaccurate usage data may result in inaccurate forecasting and customer billing.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A and 1B illustrate a system in accordance with one or more embodiments;

FIG. 2 illustrates an example set of operations for resource usage monitoring management in accordance with one or more embodiments;

FIG. 3 illustrates an example embodiment; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. RESOURCE USAGE MONITORING MANAGEMENT ARCHITECTURE
3. RESOURCE USAGE MONITORING MANAGEMENT
4. EXAMPLE EMBODIMENT
5. COMPUTER NETWORKS AND CLOUD NETWORKS
6. HARDWARE OVERVIEW
7. MISCELLANEOUS; EXTENSIONS

### 1. GENERAL OVERVIEW

Utility providers collect utility usage data from meters to plan for load distribution and future modifications to utility networks as well as bill clients for utility usage. However, many different events may cause disruptions to accurate utility monitoring, resulting in inaccurate forecasting, planning, and billing.

One or more embodiments improve the performance of a resource usage monitoring system by selectively verifying anomaly predictions generated by a machine learning model to determine a course of action for remediating confirmed anomalies and remediating a detection system in the case of false anomalies. A system verifies anomaly predictions based on sensor data by applying a machine learning model and a rules-based model to resource usage measurement data. The machine learning model predicts anomalies in the resource usage measurement data. The rules-based model verifies the predictions. The system improves the capability of the resource usage monitoring system to identify and remediate anomalies by addressing sensor-based errors validated by both the machine learning and rules-based models. The system further improves the performance of the resource usage monitoring system to remediate false anomalies by updating training datasets for training the machine learning model when an erroneous prediction of the machine learning model is detected by the rules-based model.

For example, a system may input metering data to a machine learning model to predict an anomaly in the metering data. Based on the prediction generated by the machine learning model, the system applies a rules-based model to the metering data to verify an accuracy of the prediction. If the rule-based evaluation determines that the machine-learning prediction is inaccurate, the system initiates a remediation operation to improve the predictive capability of the machine learning model. For example, the system may generate a training record using the metering data to retrain the machine learning model. If the rule-based evaluation determines that the machine learning prediction is accurate, the system initiates a remediation operation to repair and/or replace metering components and/or data generated by the meter. The system may apply a diagnostics process to the metering data to detect corrupted data. The system may apply a diagnostics process to a meter to identify faulty components in the meter. The system may further generate notifications to selected entities of anomalous metering data and incorrect machine learning predictions.

One or more embodiments modify downstream processes that use the resource-usage data based on the machine-learning-generated anomaly predictions and rules-based-model-generated anomaly verification. For example, if the machine learning model predicts anomalous resource-usage data and the rules-based model verifies the prediction, the system may omit the anomalous data from downstream functions, including resource-usage prognostication functions, resource-usage planning functions, and resource-usage compensation, recording, and management functions. The system may replace anomalous data with system-generated data, such as historical resource usage data values or averaged resource-usage data values.

One or more embodiments described in this Specification and/or recited in the claims may not be included in this General Overview section.

### 2. RESOURCE USAGE MONITORING MANAGEMENT ARCHITECTURE

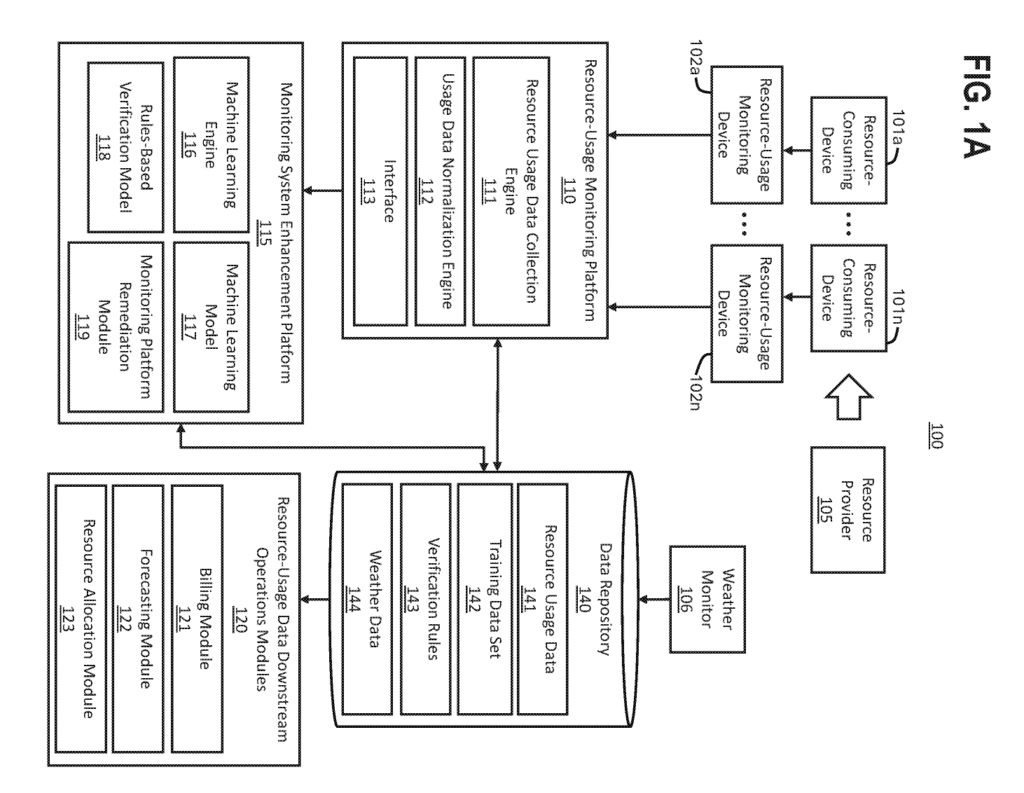

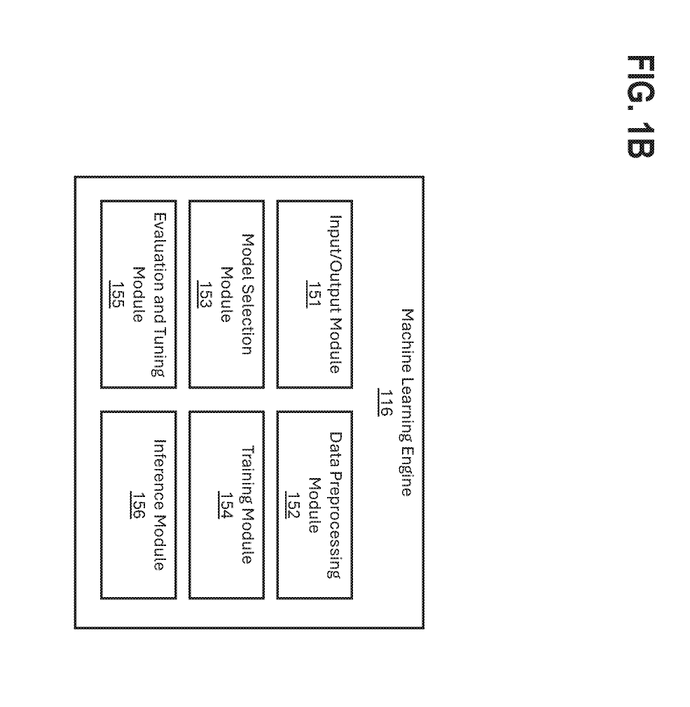

FIG. 1A illustrates a system 100 in accordance with one or more embodiments. As illustrated in FIG. 1A, system 100 includes a resource-usage monitoring platform 110, a monitoring system enhancement platform 115, resource-consuming devices 101a-101n, resource-usage monitoring devices 102a-102n, a resource provider 105, a weather monitor 106, a resource-usage data downstream operations module 120, and a data repository 140. In one or more embodiments, the system 100 may include more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component.

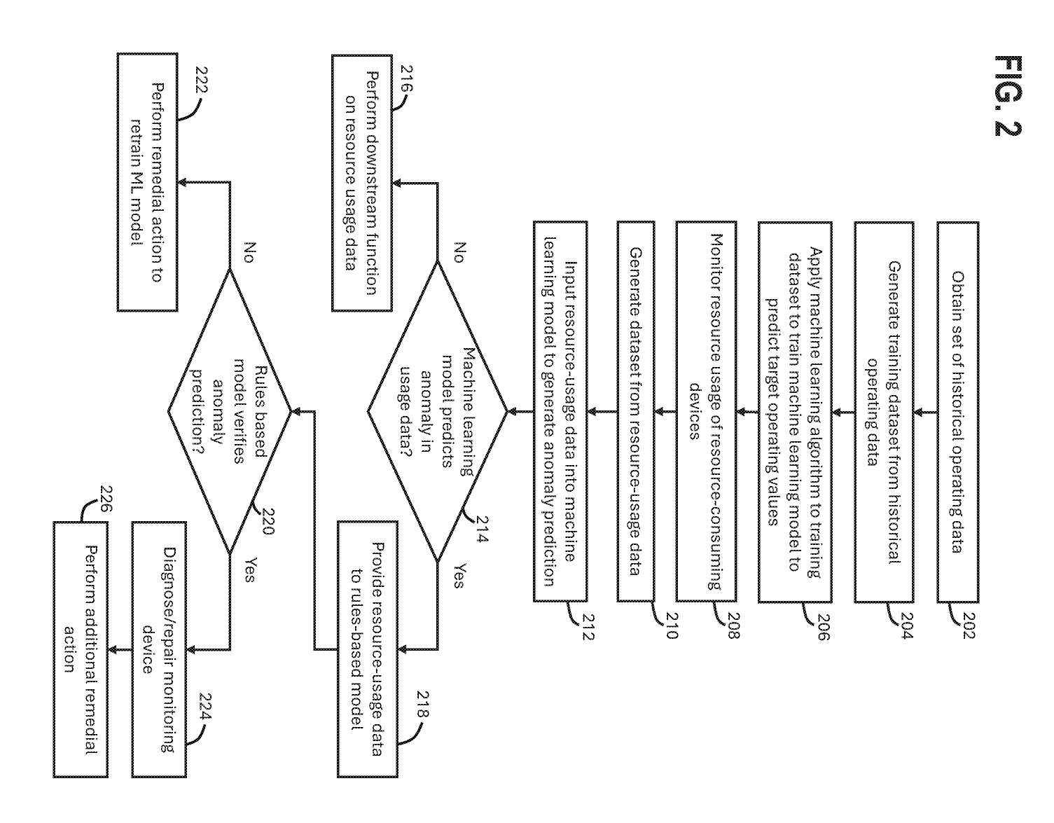

In one or more embodiments, a resource-usage monitoring platform 110 refers to hardware and/or software configured to perform operations described herein for monitoring resource usage among devices. The monitoring system enhancement platform refers to hardware and/or software configured to initiate remediation actions on monitoring devices, datasets, and/or a machine learning model based on machine-learning generated predictions verified by a rule-based model. Examples of operations for enhancing operations of a resource usage monitoring system are described below with reference to FIG. 2.

In an embodiment, the resource-usage monitoring platform 110 and monitoring system enhancement platform 115 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a server, and a mainframe.

In one or more embodiments, a data repository 140 is any type of storage unit and/or device (e.g., a file system, database, collection of tables, or any other storage mechanism) for storing data. Furthermore, a data repository 140 may include multiple different storage units and/or devices. The multiple different storage units and/or devices may or may not be of the same type or located at the same physical site. Furthermore, a data repository 140 may be implemented or executed on the same computing system as the resource-usage monitoring platform 110. Additionally, or alternatively, a data repository 140 may be implemented or executed on a computing system separate from the resource-usage monitoring platform 110. The data repository 140 may be communicatively coupled to the resource-usage monitoring platform via a direct connection or via a network.

Information describing resource usage data 141, training data sets 142, verification rules 143, and weather data 144 may be implemented across any of components within the system 100. However, this information is illustrated within the data repository 140 for purposes of clarity and explanation.

The resource-usage monitoring platform 110 collects operating data from resource-usage monitoring devices 102a-102n and stores the resource usage data 141 in a data repository 140. Monitoring devices 102a-102n monitor resource usage of resource-consuming devices 101a-101n. In one embodiment, monitoring devices 102a-102n include meters such as utility meters. For example, the monitoring devices 102a-102n may be power meters that measure the amount of power used at a particular location, such as a home, a business, a farm, etc. A monitoring device 102a-102n may include, for example, a current sensor, a voltage sensor, a sampling circuit to sample outputs generated by the current sensor and the voltage sensor, a microcontroller connected to the sampling circuit, memory connected to the microcontroller, and a communications circuit connected to the microcontroller. The monitoring devices 102a-102n may transmit resource-usage data to the resource-usage monitoring platform 110 via the communications circuit. The communications circuit may include, for example, a transceiver, such as a wireless circuit that includes an antenna, or a wired circuit that includes communications ports connected by physical wires.

Devices 101a-101n may include appliances, machines, or structures configured to consume resources. A resource provider 105 may include, for example, a utility provider. The monitoring devices 102a-102n may transmit power usage data to the resource-usage monitoring platform 110 at regular intervals. According to one example, a utility provider may receive real-time, minute-by-minute, hourly, or daily updates from a power meter regarding power usage measured by the meter.

A resource-usage data downstream operations module 120 uses resource usage data 141 to perform downstream operations on the data 141. In one embodiment, the downstream operations module 120 includes a billing module 121, a forecasting module 122, and/or a resource allocation module 123. In an embodiment, the downstream operations module 120 includes a billing module 121. The billing module 121 may apply a billing algorithm to resource usage data 141 to generate bills or invoices for customers. The forecasting module 122 may include a machine learning model trained to receive time series resource-usage data as input data and to generate a forecast of future resource-usage. The resource allocation module 123 may generate recommendations to a resource provider 105 for modifying resource capacity, such as adding or transferring resources available to devices 101a-101n.

A resource usage data collection engine 111 collects the resource usage data 141 from the resource-usage monitoring devices 102a-102n. The devices 102a-102n may communicate with the resource usage data collection engine 111 via wired or wireless communications channels. Upon receiving the resource usage data 141, the resource usage data collection engine 111 may collect additional attribute data associated with the monitoring devices 102a-102n. For example, the resource usage data collection engine 111 may identify a weather monitor 106, such as a weather station, nearest to a monitoring device 102a. The resource-usage monitoring platform 110 may store the weather data together with operating data values received for a particular time interval. Other examples of attribute data that may be stored with an operating data value as a data point include supplemental utility data such as if a location includes an alternative power generator. Attribute data may include information about a type of structure associated with the meter, such as a single-family home, an apartment, a hotel, an industrial site, a farm, a factory, a warehouse, or a storefront. The attribute data may include a size of a structure associated with the meter, such as a number of bedrooms in a home or the square-footage of the structure.

A usage data normalization engine 112 processes the received resource usage data to normalize data of various formats from various monitoring devices 102a-102n into a same data format. Normalizing resource usage data may include converting different data formats into a same type, such as “int” or “float32,” a same sampling rate, a same range of values, and a same timestamp format. Normalizing the resource usage data may include aligning data from multiple sensor streams using interpolation, resampling, and/or windowing processes. Normalizing the data may further include scaling data into a standardized range of values. For example, one monitoring device 102a may generate data in a range from 0 to 500. Another monitoring device 102n may generate data in a range from -10 to +10. The usage data normalization engine 112 may normalize the usage data from both monitoring devices to fit in a range from 0 to 20.

The resource-usage monitoring platform 110 provides resource usage data to the monitoring system enhancement platform 115. The resource-usage monitoring platform 110 and the monitoring system enhancement platform 115 may be implemented on a same device or on separate devices. The resource-usage monitoring platform 110 and the monitoring system enhancement platform 115 may be implemented as aspects of a same application or as different applications running on one or more machines.

A machine learning model 117 predicts anomalies in the resource usage data. In one or more embodiments, a machine learning model 117 applies a machine learning algorithm that can be iterated to train a target model f that best maps a set of input variables to an output variable using a set of training data. The training data includes datasets and associated labels. The datasets are associated with input variables for the target model f. The associated labels are associated with the output variable of the target model f. The training data may be updated based on, for example, feedback on the predictions by the target model f and accuracy of the current target model f. Updated training data is fed back into the machine learning algorithm that in turn updates the target model f. Additionally, or alternatively, a machine learning algorithm generates a target model f such that when the target model f is applied to the datasets of the training data, a maximum number of results determined by the target model f matches the labels of the training data. Different target models be generated based on different machine learning algorithms and/or different sets of training data.

A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

According to one embodiment, the machine learning algorithm is a deep learning long short-term memory (LSTM) autoencoder machine learning algorithm. The LSTM autoencoder machine learning algorithm is configured with sets of LSTM “cells.” Each “cell” includes a “cell state” and gates having parameters that are adjusted during training to teach the machine learning model relationships among data points in time series data. Each cell receives data via an input, outputs data via an output, and includes a “forget” gate. The input receives a data value associated with the present cell. For example, when the LSTM autoencoder algorithm is trained with time series data, one data point is associated with one cell, and a subsequent time-series data point is associated with the subsequent cell. The input gate receives a data value associated with the present cell. The “forget” gate specifies a parameter that learns which information from a previous cell should be forgotten or disregarded. The autoencoder structure of the machine learning algorithm maps input data from a high-dimensional state to a low-dimensional state and then maps the data back to the original high-dimensional state. According to one or more embodiments, the LSTM autoencoder machine learning model includes tens of thousands of parameters that are adjusted during training. For example, the LSTM autoencoder machine learning model may include between 60,000 and 70,000 parameters that are adjusted during training the machine learning model.

While an LSTM algorithm is described above by way of example, any machine learning model capable of processing time-series data as input data and identifying characteristics of particular intervals within the time series data may be utilized to generate an accuracy score based on a target set of resource-usage data and one or more historical sets of resource-usage data.

The monitoring system enhancement platform 115 includes a machine learning engine 116 for training and re-training machine learning models including the machine learning model 117. As illustrated in FIG. 1B, machine learning engine 116 includes input/output module 151, data preprocessing module 152, model selection module 153, training module 154, evaluation and tuning module 155, and inference module 156.

In accordance with an embodiment, input/output module 151 serves as the primary interface for data entering and exiting the machine learning engine 116, managing the flow and integrity of data. This module may accommodate a wide range of data sources and formats to facilitate integration and communication within the machine learning architecture.

In an embodiment, an input handler within input/output module 151 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 151 to be versatile in different operational contexts, whether processing historical datasets or streaming data.

In accordance with an embodiment, input/output module 151 manages data integrity and quality as it enters the system by incorporating initial checks and validations. These checks and validations ensure that incoming data meet predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 151 includes an output framework designed to handle the distribution and exportation of outputs, predictions, or insights. Using the output framework, input/output module 151 formats these outputs into user-friendly and accessible formats, such as reports, visualizations, or data files compatible with other systems. Input/output module 151 also ensures secure and efficient transmission of these outputs to end-users or other systems in an embodiment and may employ encryption and secure data transfer protocols to maintain data confidentiality.

In accordance with an embodiment, data preprocessing module 152 transforms data into a format suitable for use by other modules in machine learning engine 116. For example, data preprocessing module 152 may transform raw data into a normalized or standardized format suitable for training machine learning models and for processing new data inputs for inference. In an embodiment, data preprocessing module 152 acts as a bridge between the raw data sources and the analytical capabilities of machine learning engine 116.

In an embodiment, data preprocessing module 152 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods, like imputation or removal of incomplete records, depending on the nature and volume of the missing data. Data preprocessing module 152 may be configured to handle anomalies in different ways, depending on context. Data preprocessing module 152 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model’s ability to learn effectively.

In an embodiment, data preprocessing module 152 includes a feature encoding framework that ensures categorical variables are transformed into a format that can be easily interpreted by machine learning algorithms. Techniques, such as one-hot encoding or label encoding, may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 152 processes new data for inference, data preprocessing module 152 replicates the same preprocessing steps to ensure consistency with the training data format. This helps to avoid discrepancies between the training data format and the inference data format, thereby reducing the likelihood of inaccurate or invalid model predictions.

In an embodiment, model selection module 153 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 153 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 153 utilizes techniques from the field of Automated Machine Learning (AutoML). AutoML systems automate the process of model selection by rapidly prototyping and evaluating multiple models. They use various techniques, like Bayesian optimization, genetic algorithms, or reinforcement learning, to explore the model space efficiently. Model selection module 153 may use these techniques to evaluate each candidate model based on performance metrics relevant to the task. For example, accuracy, precision, recall, or F1 score may be used for classification tasks, and mean squared error metrics may be used for regression tasks. Accuracy measures the proportion of correct predictions, both positive and negative. Precision measures the proportion of actual positives among the predicted positive cases. Recall, also known as sensitivity, evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model’s accuracy. A lower MSE may indicate a model’s greater accuracy in predicting values, for it represents a smaller average discrepancy between the actual and predicted values.

In accordance with an embodiment, model selection module 153 also considers computational efficiency and resource constraints. This is meant to help ensure the selected model is both accurate and practical in terms of computational and time requirements. In an embodiment, certain features of model selection module 153 are configurable such as a configured bias toward (or against) computational efficiency.

In accordance with an embodiment, training module 154 manages the ‘learning’ process of machine learning models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 154 handles the iterative process of feeding the training data into the model, adjusting the model’s internal parameters, like weights in neural networks, through backpropagation and optimization algorithms, such as stochastic gradient descent or other algorithms providing similarly useful results.

In accordance with an embodiment, training module 154 manages overfitting, where a model learns the training data too well, including its noise and outliers, at the expense of its ability to generalize to new data. Techniques, such as regularization, dropout (in neural networks), and early stopping, are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 154 includes logic to handle different types of data and learning tasks. For instance, it includes different training routines for supervised learning, where the training data comes with labels, and unsupervised learning without labeled data. In the case of deep learning models, training module 154 also manages the complexities of training neural networks that include initializing network weights, choosing activation functions, and setting up neural network layers.

In an embodiment, evaluation and tuning module 155 incorporates dynamic feedback mechanisms and facilitates continuous model evolution to help ensure the system’s relevance and accuracy as the data landscape changes. Evaluation and tuning module 155 conducts a detailed evaluation of a model’s performance. This process involves using statistical methods and a variety of performance metrics to analyze the model’s predictions against a validation dataset. The validation dataset, distinct from the training set, is instrumental in assessing the model’s predictive accuracy and its capacity to generalize beyond the training data. The module’s algorithms meticulously dissect the model’s output, uncovering biases, variances, and the overall effectiveness of the model in capturing the underlying patterns of the data.

In an embodiment, evaluation and tuning module 155 performs continuous model tuning by using hyperparameter optimization. Evaluation and tuning module 155 performs an exploration of the hyperparameter space using algorithms, such as grid search, random search, or more sophisticated methods like Bayesian optimization. Evaluation and tuning module 155 uses these algorithms to iteratively adjust and refine the model’s hyperparameters – settings that govern the model’s learning process but are not directly learned from the data – to enhance the model’s performance. This tuning process helps to balance the model’s complexity with its ability to generalize and attempts to avoid the pitfalls of underfitting or overfitting.

In an embodiment, evaluation and tuning module 155 integrates data feedback and updates the model. Evaluation and tuning module 155 actively collects feedback from the model’s real-world applications, an indicator of the model’s performance in practical scenarios. Such feedback can come from various sources, depending on the nature of the application. For example, in a user-centric application, such as a recommendation system, feedback might comprise user interactions, preferences, and responses. In other contexts, like predicting events, it might involve analyzing the model’s prediction errors, misclassifications, or other performance metrics in live environments.

In an embodiment, feedback integration logic within evaluation and tuning module 155 integrates this feedback using a process of assimilating new data patterns, user interactions, and error trends into the system’s knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 155 employs version control mechanisms to track changes, modifications, and the evolution of the model, facilitating transparency and allowing for rollback if necessary. This continuous learning and adaptation cycle, driven by real-world data and feedback, helps to endure the model’s ongoing effectiveness, relevance, and accuracy.

In an embodiment, inference module 156 transforms raw data into actionable, precise, and contextually relevant predictions. In addition to processing and applying a trained model to new data, inference module 156 may also include post-processing logic that refines the raw outputs of the model into meaningful insights.

In an embodiment, inference module 156 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 156 transforms the outputs of a trained model into definitive classifications. Inference module 156 employs the underlying model as a tool to generate probabilistic outputs for each potential class. It then engages in an interpretative process to convert these probabilities into concrete class labels.

In an embodiment, when inference module 156 receives the probabilistic outputs from the model, it analyzes these probabilities to determine how they are distributed across some, or every, potential class. If the highest probability is not significantly greater than the others, inference module 156 may determine that there is ambiguity or interpret this as a lack of confidence displayed by the model.

In an embodiment, inference module 156 uses thresholding techniques for applications, where making a definitive decision based on the highest probability might not suffice due to the critical nature of the decision. In such cases, inference module 156 assesses if the highest probability surpasses a certain confidence threshold that is predetermined based on the specific requirements of the application. If the probabilities do not meet this threshold, inference module 156 may flag the result as uncertain or defer the decision to a human expert. Inference module 156 dynamically adjusts the decision thresholds based on the sensitivity and specificity requirements of the application subject to calibration for balancing the trade-offs between false positives and false negatives.

In accordance with an embodiment, inference module 156 contextualizes the probability distribution against the backdrop of the specific application. This involves a comparative analysis, especially in instances where multiple classes have similar probability scores, to deduce the most plausible classification. In an embodiment, inference module 156 may incorporate additional decision-making rules or contextual information to guide this analysis, ensuring that the classification aligns with the practical and contextual nuances of the application.

In regression models, where the outputs are continuous values, inference module 156 may engage in a detailed scaling process in an embodiment. Outputs, often normalized or standardized during training for optimal model performance, are rescaled back to their original range. This rescaling involves recalibration of the output values using the original data’s statistical parameters, such as mean and standard deviation, ensuring that the predictions are meaningful and comparable to the real-world scales they represent.

In an embodiment, inference module 156 incorporates domain-specific adjustments into its post-processing routine. This involves tailoring the model’s output to align with specific industry knowledge or contextual information. For example, in financial forecasting, inference module 156 may adjust predictions based on current market trends, economic indicators, or recent significant events, ensuring that the outputs are both statistically accurate and practically relevant.

In an embodiment, inference module 156 includes logic to handle uncertainty and ambiguity in the model’s predictions. In cases where inference module 156 outputs a measure of uncertainty, such as in Bayesian inference models, inference module 156 interprets these uncertainty measures by converting probabilistic distributions or confidence intervals into a format that can be easily understood and acted upon. This provides users with both a prediction and an insight into the confidence level of that prediction. In an embodiment, inference module 156 includes mechanisms for involving human oversight or integrating the instance into a feedback loop for subsequent analysis and model refinement.

In an embodiment, inference module 156 formats the final predictions for end-user consumption. Predictions are converted into visualizations, user-friendly reports, or interactive interfaces. In some systems, like recommendation engines, inference module 156 also integrates feedback mechanisms, where user responses to the predictions are used to continually refine and improve the model, creating a dynamic, self-improving system.

In an embodiment, input/output module 151 receives a dataset intended for training. This data can originate from diverse sources, like databases or real-time data streams, and in varied formats, such as CSV, JSON, or XML. In one embodiment, the dataset includes resource usage data 141 generated by the resource-usage monitoring devices 102a-102n. Input/output module 151 assesses and validates the data, ensuring its integrity by checking for consistency, data ranges, and types.

In an embodiment, training data is passed to data preprocessing module 152. Here, the data undergoes a series of transformations to standardize and clean it, making it suitable for training ML models. This involves normalizing numerical data, encoding categorical variables, and handling missing values through techniques like imputation.

In an embodiment, prepared data from the data preprocessing module 152 is then fed into model selection module 153. This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 154 trains the selected model with the prepared dataset. It implements learning algorithms to adjust the model’s internal parameters, optimizing them to identify patterns and relationships in the training data. Training module 154 also addresses the challenge of overfitting by implementing techniques, like regularization and early stopping, ensuring the model’s generalizability.

According to an example embodiment, the machine learning model 117 includes a neural network. For example, the machine learning model 117 may be implemented as a deep-learning neural networks. The training module 154 applies a machine learning algorithm to a training data set 142 to train the machine learning model 117. For example, the machine learning algorithm may analyze the training data set 142 to train neurons of a neural network with particular weights and offsets to associate particular sets of task attributes, node attributes, and network attributes with particular offload decisions.

In some embodiments, the training module 154 iteratively applies the machine learning algorithm to a set of input data to generate an output set of labels, compares the generate labels to pre-generated labels associated with the input data, adjusts weights and offsets of the algorithm based on an error, and applies the algorithm to another set of input data. In some cases, the training module 154 may generate and train a candidate recurrent neural network model such as a long short-term memory (LSTM) model. With recurrent neural networks, one or more network nodes or “cells” may include a memory. A memory allows individual nodes in the neural network to capture dependencies based on the order in which feature vectors are fed through the model. The weights applied to a feature vector representing one feature may depend on its position within a sequence of feature vector representations. Thus, the nodes may have a memory to remember relevant temporal dependencies between different sets of input features.

In some embodiments, the training module 154 compares the labels estimated through the one or more iterations of the machine learning model algorithm with observed labels to determine an estimation error. The training module 154 may perform this comparison for a test set of examples, which may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the training module 154 determines whether to adjust the weights and/or other model parameters based on the estimation error. Adjustments may be made until a candidate model that minimizes the estimation error or otherwise achieves a threshold level of estimation error is identified. In some embodiments, the training module 154 selects machine learning model parameters based on the estimation error meeting a threshold accuracy level. For example, the system may select a set of parameter values for a machine learning model based on determining that the trained model has an accuracy level for predicting labels of at least 98%.

In an embodiment, evaluation and tuning module 155 evaluates the trained model’s performance using the validation dataset. Evaluation and tuning module 155 applies various metrics to assess predictive accuracy and generalization capabilities. It then tunes the model by adjusting hyperparameters, and if needed, incorporates feedback from the model’s initial deployments, retraining the model with new data patterns identified from the feedback.

In an embodiment, input/output module 151 receives a dataset intended for inference. The dataset includes resource usage data 141 obtained from resource-usage monitoring devices 102a-102n. The dataset may further include weather data 144, describing weather conditions associated with the monitoring devices 102a-102n. Input/output module 151 assesses and validates the data.

In an embodiment, data preprocessing module 152 receives the validated dataset intended for inference. Data preprocessing module 152 ensures that the data format used in training is replicated for the new inference data, maintaining consistency and accuracy for the model’s predictions.

In an embodiment, inference module 156 processes the new data set intended for inference, using the trained and tuned model 117. It applies the model 117 to this data, generating raw probabilistic outputs for predictions. Inference module 156 then executes a series of post-processing steps on these outputs, such as converting probabilities to class labels in classification tasks or rescaling values in regression tasks. It contextualizes the outputs as per the application’s requirements, handling any uncertainty in predictions and formatting the final outputs for end-user consumption or integration into larger systems.

In an embodiment, the machine learning model 117 is trained to generate an accuracy score. The accuracy score is a numerical value predicting an accuracy of resource usage data 141 obtained from a resource-usage monitoring device such as the monitoring device 102a. In an embodiment, the machine learning model 117 is trained to receive time-series data as input data to predict if resource usage data 141 for a particular time period is accurate. For example, the model 117 may learn, through training, resource usage trends and expected usage values. The model 117 may generate an accuracy score based on differences between resource usage data for a target time period and learned expected resource usage values. The inference module 156 may compare the accuracy score generated by the model 117 to a threshold to predict if the predicated accuracy score corresponds to a predicted anomaly.

The resource-usage monitoring platform 110 further includes a rules-based verification model 118. The rules-based verification model 118 applies verification rules 143 to resource usage data 141 to verify anomaly predictions generated by the machine learning model 117. If the machine learning model 117 determines no anomaly exists in resource usage data, the system may refrain from applying the verification rules 143 to the resource usage data 141. If the machine learning model 117 predicts an anomaly in the resource usage data 141, the system applies the rules-based verification model 118 to the resource usage data 141. Verification rules 143 may include, for example, rules specifying a range of values, a format, cross-field consistency, and valid values (e.g., positive integers) for resource usage data 141. The rules 143 may further specify estimation processes, such as determining if a set of resource usage data 141 falls within a calculated mean of historical data. Verification rules 143 may further specify rules to ensure resource usage data 141 includes a number of missing values less than defined thresholds.

The resource-usage monitoring platform 110 further includes a monitoring platform remediation module 119. The monitoring platform remediation module 119 recommends or initiates remedial operations based on detecting at least one of (a) an anomaly in resource usage data 141 or (b) a false anomaly prediction by the machine learning model 117. For example, if the machine learning model 117 predicts an anomaly and the rules-based verification model 118 verifies the anomaly, the monitoring platform remediation module 119 may initiate diagnostic operations in a resource-usage monitoring device 102a-102n to diagnose a fault in the device. In addition, if the machine learning model 117 predicts an anomaly and the rules-based verification model 118 determines the prediction was incorrect, the remediation module 119 may initiate retraining of the machine learning model 117.

In one or more embodiments, interface 113 refers to hardware and/or software configured to facilitate communications between a user and the resource-usage monitoring platform 110. Interface 113 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 113 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 113 is specified in one or more other languages, such as Java, C, or C++.

Additional embodiments and/or examples relating to computer networks are described below in Section 5, titled “Computer Networks and Cloud Networks.”

### 3. RESOURCE USAGE MONITORING MANAGEMENT

FIG. 2 illustrates an example set of operations for remediating errors in resource usage monitoring and anomaly prediction in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

A system obtains a set of historical data (Operation 202). The historical data includes operating data values and attributes associated with the operation of one or more monitored devices. Examples of operating data values include power or other utility usage levels and calendar data such as a timestamp associated with usage levels. Examples of attributes associated with the operating data values include weather data, location data, data describing a type of facility or structure utilizing a utility (e.g., commercial, retail, industrial), data describing a size of the structure, such as a number of bedrooms, rooms, or square footage, data describing how the structure is used (e.g., private home, hotel, data center, farmland, factory, storefront, warehouse), and data specifying if a location is associated with relevant features, such as solar panels, wind turbine, or a pool.

The system generates a training data set from the historical operating data (Operation 204). The training data set includes data points specifying operating data values and attributes associated with monitored devices generating the operating values. For example, a data point may include a kWh power consumption over the course of an hour and weather at a location associated with a meter generating the kWh power consumption value.

The system applies a machine learning algorithm to the training dataset to train a machine learning model to predict target operating values (Operation 206). According to one embodiment, the machine learning algorithm accepts time series data as input. The time series data is obtained over a specified period of time. The period of time of a time-series segment provided to the machine learning algorithm is separated into incremental intervals. Each interval has its own operating data value and its own additional attributes. For example, the algorithm may accept as input data a time-series segment comprising 30 days of data points. Each data point specifies an amount of power in kWh consumed on a particular day, a weather state associated with the particular day, and any additional attributes included in the time series data. Based on the relationships (a) between attributes within a particular data point and (b) attributes between different data points in the same time-series segment, the system adjusts parameters of the machine learning algorithm to train a machine learning model.

According to one embodiment, the machine learning algorithm is a deep learning long short-term memory (LSTM) autoencoder machine learning algorithm. The LSTM autoencoder machine learning algorithm is configured with sets of LSTM “cells.” Each “cell” includes a “cell state” and gates having parameters that are adjusted during training to teach the machine learning model relationships among data points in time series data. Each cell receives data via an input, outputs data via an output, and includes a “forget” gate. The input receives a data value associated with the present cell. For example, when the LSTM autoencoder algorithm is trained with time series data, one data point is associated with one cell, and a subsequent time-series data point is associated with the subsequent cell. The input gate receives a data value associated with the present cell. The “forget” gate specifies a parameter that learns which information from a previous cell should be forgotten or disregarded. The autoencoder structure of the machine learning algorithm maps input data from a high-dimensional state to a low-dimensional state and then maps data back to the original high-dimensional state. According to one or more embodiments, the LSTM autoencoder machine learning model includes tens of thousands of parameters that are adjusted during training. For example, the LSTM autoencoder machine learning model may include between 60,000 and 70,000 parameters that are adjusted during training the machine learning model.

While an LSTM algorithm is described above by way of example, any machine learning model capable of processing time-series data as input data and identifying characteristics of particular intervals within the time series data may be utilized.

For example, in an alternative embodiment, the machine learning model is a classification-type model such as a classification-type neural network. In some embodiments, the system iteratively applies the machine learning algorithm to a set of input data to generate an output set of labels, compares the generated labels to pre-generated labels associated with the input data, adjusts weights and offsets of the algorithm based on an error, and applies the algorithm to another set of input data.

In some embodiments, the system compares the labels estimated through the one or more iterations of the machine learning model algorithm with observed labels to determine an estimation error. The system may perform this comparison for a test set of examples, which may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the system determines whether to adjust the weights and/or other model parameters based on the estimation error. Adjustments may be made until a candidate model that minimizes the estimation error or otherwise achieves a threshold level of estimation error is identified. The process may make adjustments and continue training the machine learning model.

In some embodiments, the system selects machine learning model parameters based on the estimation error meeting a threshold accuracy level. For example, the system may select a set of parameter values for a machine learning model based on determining that the trained model has an accuracy level for predicting labels for medical claims of at least 98%.

In an embodiment, the system monitors the resource usage of one or more resource-consuming devices (Operation 208). The system receives data transmissions from resource-usage monitors. In an example embodiment, resources are utilities, such as power, water, and gas, and resource-usage monitors are meters. For example, a system may monitor power usage of an entity associated with a building or structure using a meter. The meter may include sensors to measure and track resource usage. Alternatively, resources may include computing resources, such as processing capacity, memory, virtual machines, and input/output (I/O), application usage, computing node usage, execution of database queries, and usage of applications, processes, and hardware in a computing environment.

Receiving data transmissions from resource-usage monitors may include transmitting sensor data and/or meter data along a communication channel including one or both of wired and wireless components. A monitoring platform may receive the sensor data and/or meter data in data streams, at defined intervals, upon request, in real-time, or as accumulated data transmitted as a batch. A system may receive resource usage data from multiple different sources. The sources may generate resource usage data in varying formats. The system normalizes resource usage data received in varying formats to generate sets of resources usage data in a uniform format.

The system generates a dataset from the resource-usage data (Operation 210). Generating a dataset may include aggregating resource usage data from multiple sources or over time into a single dataset. Generating the dataset may further include supplementing resource usage data with additional data. Additional data may include, for example, environmental data associated with a resource usage monitor and calculated metrics, such as average values, mean values, and median values. Environmental data may include sensor data of additional sensors in the vicinity of a particular resource usage meter. Environmental data may include weather data of a region where a resource usage meter is located.

The system inputs resource-usage data into a machine learning model to generate an anomaly prediction (Operation 212). According to one embodiment, the machine learning model is a classification-type model. The classification-type model receives a set of resource-usage data as input data and generates an output that classifies the input data as anomalous or not-anomalous. The output may classify the input data as corresponding to a particular type of anomaly, such as describing too high a resource usage, too low a resource usage, or too sparse a set of input data (e.g., missing too many feature values).

According to an alternative embodiment, the machine learning model is trained to (a) predict resource usage values and (b) generate an accuracy score predicting an accuracy of input resource usage data. The input data to the machine learning model may include historical usage data and target usage data. The model predicts the accuracy of the target usage data based on the historical usage data. Through training, the model may learn trends, expected high usage values, expected low usage values, ranges of usage values, and expected variations of usage values within defined timeframes.

Inputting the resource-usage data to the machine learning model may include converting raw data into an input vector. Raw data may include sensor and metric values in a particular format. The system may convert the raw data into sets of numerical values in a defined format that is consumable by the machine learning model.

The system determines if the machine learning model predicts an anomaly based on the resource usage data (Operation 214). Anomalies may include the following: predicting a resource usage value is too high or too low in a particular timeframe, predicting a variation in resource usage values in the timeframe is anomalous, and predicting a defined number of measured values in a set of time-series data is anomalous (e.g., predicting the number of data points with no data exceeds threshold).

In an embodiment, a machine learning model generates an accuracy score associated with a target set of resource usage data. The accuracy score may be based on the machine learning model predicting the accuracy of the target set of resource usage data compared to historical sets of resource usage data. In an embodiment, the machine learning model predicts a resource usage value for a defined timeframe. The system may compare the predicted resource usage value to the resource usage values actually measured to generate the accuracy score for the measured resource usage values.

In an embodiment, for each data point associated with an interval of the time series data, the system compares the predicted target value generated by the machine learning model based on analyzing multiple data points of the time series data to the actual value of the interval in the time-series data. The system calculates an anomaly score for each data point in the time-series data set based on the difference between the predicted target value for the data point and the actual value associated with the data point. In other words, the more the actual operating data value for a data point differs from the predicted target operating value, the greater the anomaly score. If the difference between the predicted target values and the actual values exceeds a threshold, the system identifies a particular data point as being anomalous.

In an embodiment, the system determines if anomaly scores exceed a threshold. The threshold may include one or both of (a) a threshold difference between a predicted value for a data point and the actual value for the data point and (b) a threshold number of data points within a set of data points that is anomalous. For example, the threshold may specify 50% or more of a set of 20 data points being anomalous by more than 10% of predicted values. A data set in which 40% of the data points were anomalous by more than 10% of predicted values would not meet the threshold. The threshold may include multiple tiers. For example, the threshold may specify (a) 50% or more of a set of 20 data points being anomalous by more than 10% of predicted values or (b) 10% or more of a set of 20 data points being anomalous by more than 30% of predicted values. In other words, the threshold may be set to define a sliding scale requiring more anomalous data points of lower severity or fewer anomalous data points of higher severity. If an anomalous data point or set of data points exceeds a threshold, the system selects a remedial action to perform associated with a detected anomaly in a set of time-series data.

If the machine learning model does not predict an anomaly, the system provides the resource usage data to an application or platform to perform a downstream function (Operation 216). Examples of downstream functions include a billing platform to generate bills to customers for utility usage, a resource usage prediction platform that predicts future resource usage among a set of customers, organizations, or other entities, and a resource allocation platform that uses predicted resource usage to allocate resources among entities.

If the machine learning model predicts an anomaly based on the resource usage data, the system verifies the anomaly prediction by inputting the resource-usage data to a rules-based model (Operation 218). The rules-based model specifies a set of rules for determining if resource usage data is anomalous. The rules may include, for example, minimum and maximum usage values for time intervals in a defined timeframe, minimum and maximum aggregate usage values for the timeframe, minimum and maximum variation values for a timeframe, minimum and maximum variations from a mean usage value in the timeframe, a change in minimum, maximum, and/or aggregate usage values for a target timeframe compared to a historical timeframe such as the same month in the previous year. The rules may be entity specific. For example, a system may apply one set of rules to one customer and another set of rules to another customer.

Based on inputting the resource-usage data to the rules-based model, the system verifies if the anomaly prediction generated by the machine learning model is valid (Operation 220). The system may determine the anomaly prediction is valid based on determining the resource-usage data attributes comply with rules that specify conditions for determining data is anomalous. Conversely, the system may determine the anomaly prediction is not valid based on determining the resource-usage data attributes do not comply with any rules specifying conditions for determining data is anomalous.

If the rules-based model determines the anomaly prediction generated by the machine learning model is not valid, the system performs a remedial action to retrain the machine learning model (Operation 222). The system may generate a training record that includes attributes of the resource-usage data and a label indicating the resource-usage data is non-anomalous. Alternatively, the system may generate a training record based on resource-usage data that includes (a) predicted usage data for a target timeframe and (b) measured usage data for the target timeframe. The training record may include an accuracy score label based on a difference between the predicated usage data and the measured usage data. For example, if the machine learning model previously predicted the usage data for the target timeframe was anomalous based on an accuracy score failing to meet a threshold, the system may generate the training record with an accuracy score that exceeds the threshold.

The system may retrain the machine learning model with the newly generated training record. The system may accumulate training records generated by the system until a threshold number of training records is generated. Additionally, or alternatively, the system may generate a set of synthetic training records based on the newly generated training record. The system may generate the synthetic training records in sufficient numbers to train the machine learning model to generate a desired accuracy score for a particular set of (a) predicated usage data and (b) measured usage data.

If the rules-based model determines the anomaly prediction generated by the machine learning model is valid, the system initiates remedial actions to diagnose and/or repair a monitoring device (Operation 224). An anomaly in a set of resource-usage data may be a result of a faulty sensor or resource-usage monitoring meter. The system may initiate electronic communications with the sensor and/or meter to initiate diagnostics. The system may identify components that require servicing, repair, and/or replacement. In one example, a system may initiate a remote reset of a meter and modify data in the software code running on the meter. The system may generate a service ticket to direct a technician to diagnose and/or repair the sensor or meter.

The system may perform additional remedial actions based on determining the machine learning anomaly prediction is valid (Operation 226). For example, the system may purge a record including the resource-usage data from a downstream process. A downstream process may include a billing process, a system modeling process, a prediction process, or a resource-allocation process. In an example where the downstream process is a billing process, the system may refrain from billing a customer based on values included in the resource-usage data. The system may replace the measured values with the estimated values or a default value. In an example where the downstream process is a system modeling process, a prediction process, or a resource-allocation process, the system may replace the anomalous resource-usage data with estimated values. Alternatively, the system may perform the downstream processes with the anomalous usage data omitted and without replacing the anomalous data.

According to another example, the system may transmit a communication to an entity associated with a meter to request that the entity confirm that the measured resource-usage data is correct or confirm the measured data is anomalous. If the system receives feedback that the resource-usage data that was predicted as anomalous was, in fact, valid, the system may initiate remediation actions to (a) retrain the machine learning model and (b) modify the rule-based model.

The system may select the remedial action according to the severity of the detected anomaly. For example, if the system detects in a set of time-series data an anomaly associated with a data transmission failure that has been resolved, the system may refrain from performing further remedial action. If the system detects in the set of time-series data an anomaly associated with a utility transmission failure, the system may trigger a notification to a utility service provider that a repair may be required. According to one example embodiment, the system analyzes utility usage for a particular billing period to determine if an amount billed to a customer is accurate. If the system detects an anomaly with a pattern associated with the theft of the utility, such as an unauthorized use of power from a particular location, within time-series data for a billing period, the system may generate a notification to the customer suggesting the customer review a charge. Additionally, or alternatively, the system may refrain from including charges associated with the anomalous usage in a customer’s bill.

### 4. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

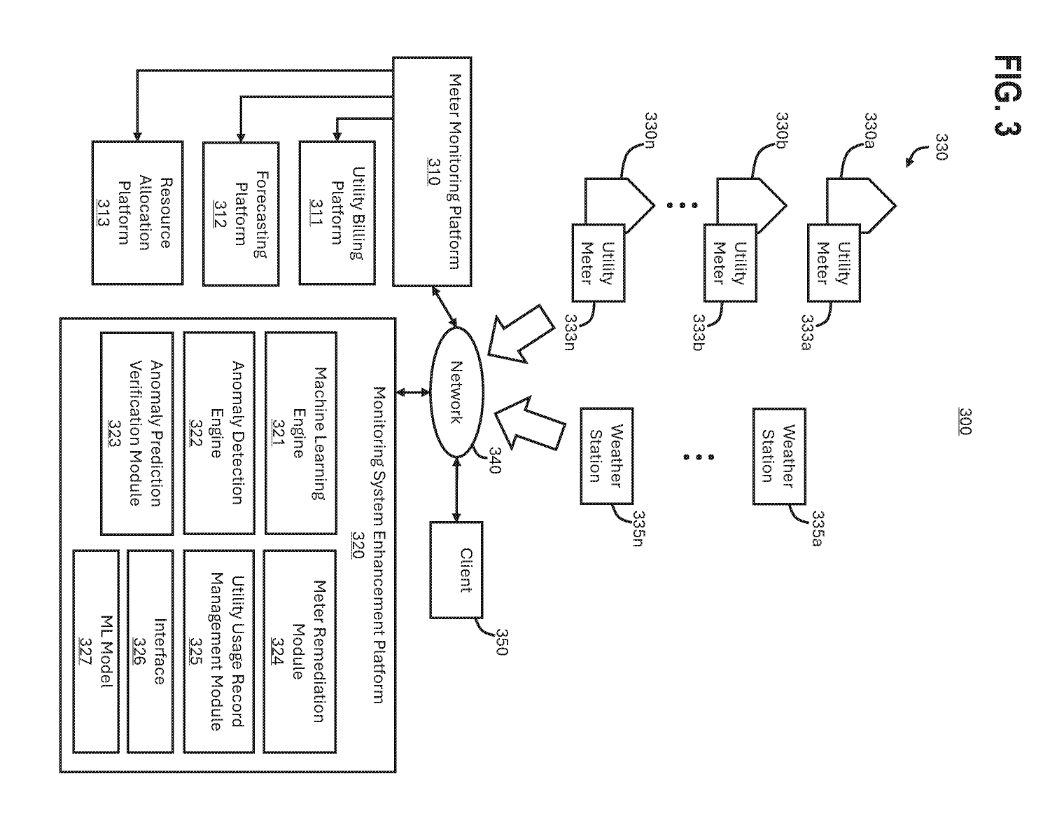

FIG. 3 illustrates a system 300 for monitoring power usage using Advanced Metering Infrastructure (AMI) technology. The system 300 includes dwellings 330a-330n. The dwellings 330a-330n are connected to a power utility network. Power usage at the dwellings 330a-330n is monitored by meters 333a-333n. The meters 333a-333n transmit power usage data to a meter monitoring platform 310 via a network 340. The network may include a global data network such as the Internet.

The meter monitoring platform 310 receives power usage data from the meters 333a-333n. The meter monitoring platform 310 may process the power usage data to convert the power usage data from disparate formats to a uniform format. The meter monitoring platform 310 may normalize power usage data by removing native formatting of power usage data and re-formatting the power usage data according to a uniform formatting, such as storing power usage data in defined fields: timestamp, device ID, device type, data type, and power usage value.

The meter monitoring platform 310 provides the normalized power usage data to a utility billing platform 311 to generate utility bills based on the power usage data. Generating a utility bill includes identifying usage data for a particular dwelling 330a-330n for a particular time period and applying predefined billing rates to the power usage data. The meter monitoring platform 310 further provides the normalized power usage data to the forecasting platform 312 to forecast future power usage. Providing the normalized power usage data to the forecasting platform 312 includes generating a set of time-series data for one or more dwellings 330a-330n. The forecasting platform 312 provides the time-series data to a forecasting model to generate a forecast for future power usage for a dwelling 330a-330n. The meter monitoring platform 310 provides the normalized power usage data to a resource allocation platform 313 to manage the allocation of power resources in the utility grid. The forecasting platform 312 may further provide resource usage forecasting data to the resource allocation platform 313. The resource allocation platform 313 manages resource allocation in the power grid. Resource allocation includes controlling power generated by power generation sources. For example, the resource allocation platform 313 may control the connection and disconnection of power generation sources to a power grid. The resource allocation platform 313 may turn on and off power generators and control a rate of power generation. The power allocation platform may change angles of solar panels and wind turbines to change power generation rates.

The meter monitoring platform 310 transmits the normalized power usage data to the monitoring system enhancement platform 320. The monitoring system enhancement platform 320 detects and remediates anomalies in a power usage monitoring system 300 by identifying anomalies in power usage data and models that predict the anomalies.

A machine learning engine 321 generates a training data set from historical time-series data obtained from the dwellings 330. The machine learning engine 321 trains a machine learning model 327 to predict target operating values for meters. The machine learning model 327 is applied to time-series data generated by one of the meters 333a-333n or to another meter determined to have characteristics similar to the meters 333a-333n. For example, the monitoring system enhancement platform 320 may apply the machine learning model 327 to any meters within a specified geographic region and associated with single family dwellings.

The machine learning engine 321 trains the machine learning model 327 to identify relationships (a) between attributes within a same data point and (b) between attributes of different data points in a same set of time-series data. The machine learning model 327 is a deep LSTM autoencoder machine learning model.

Upon training the machine learning model 327, the meter monitoring platform 310 obtains target time-series meter data. The target time-series meter data is data generated by one or more power meters, such as the power meter 333a of the dwelling 330a. The meter 333a associated with the target time-series meter data may be among the set of meters providing data for training the machine learning model 327. Alternatively, the meter 333a may not have been among the set of meters used to train the machine learning model 327.

The target time-series meter data may be Net Advanced Metering Infrastructure (AMI) data. Net AMI data includes values that reflect power supplied to a customer from a utility supplier and power generated by the customer such as by solar panels. For example, in some solar systems, solar panels do not power the dwelling on which they are mounted. Instead, a utility company provides all power to the dwelling, the solar panels feed electricity back into the power grid, and the utility company deducts the cost of the electricity from a utility bill associated with the dwelling. The target time-series meter data may include meter values that include power provided from a utility provider minus power generated by solar panels and sold back to the utility provider. While solar panels are described in the example embodiment, additional power sources that generate power at a dwelling that may be sold to a utility company include wind turbines and geothermal generators.

The target time-series meter data in the example embodiment corresponds to a duration of one month. The target time-series meter data includes separate data points for each hour-interval within the one month period of time. For example, if the month is 30 days, the target time-series data includes 720 separate data points, each data point including (a) a meter value (e.g., power consumed in kWh), (b) a timestamp, and (c) additional attribute data, such as weather data or attribute data about the monitored location (e.g., the dwelling 330a includes solar panels or that the dwelling 330b includes a pool).

In the example embodiment, a meter location identifier determines a location of a meter generating the target time-series meter data. The location may be an address, coordinates, or a region. The additional data collection engine includes a weather station locator to locate a weather station 335a or 335n in the vicinity of the meter location. The weather station may be the closest weather station to the meter generating the target time-series meter data. The monitoring platform 310 collects additional data about a facility being monitored by the meter, including unique power-consumption properties. For example, the monitoring platform 310 may determine if the dwelling 330a includes solar panels and/or a pool, is associated with a high-power-consuming operation, such as a data center, or is a multi-residence building.

The monitoring system enhancement platform 320 provides the target time-series meter data and the additional time series attribute data to the machine learning model 327 to generate a power usage predicted value for each data point of the target time-series meter data. The set of predicted values for the target time-series meter data is the predicted time series meter data.

An anomaly detection engine 322 analyzes the predicted time-series meter data generated by the machine learning model 327 to detect anomalies among the intervals in the data. The anomaly detection engine 322 identifies data points, corresponding to hours of time within the month time period, that have anomalous values. An anomaly detection engine 322 determines that values are anomalous based on calculating an anomaly score for each data point in the time-series data set. The anomaly score is based on the difference between the predicted target value for the data point and the actual value associated with the data point. If the difference between the predicted target values and the actual values exceeds a threshold, the system identifies a particular data point as being anomalous. A higher difference between a predicted meter value and a measured meter value corresponds to a higher anomaly score. A lower difference between a predicted meter value and a measured meter value corresponds to a lower anomaly score. The anomaly detection engine 322 detects anomalies based on pre-defined time periods. For example, the anomaly detection engine 322 may detect an anomaly based on detecting a difference between a predicted power usage value over a month and a measured power usage value over the month.

If the anomaly detection engine 322 detects anomalous power usage data, the monitoring system enhancement platform 320 provides the power usage data to the anomaly prediction verification module 323. The anomaly prediction verification module 323 is a rule-based model. The rules specify conditions for verifying anomalies. For example, the anomaly prediction verification module 323 may verify a preliminary determination of anomalous power usage data is correct based on determining a difference between a maximum predicted power usage value over a month and the maximum measured power usage value over the month exceeds a threshold. Conversely, if the difference between the maximum predicted power usage value over a month and the maximum measured power usage value over the month does not exceed the threshold, a set of power usage data may not be anomalous. The anomaly prediction verification module 323 may verify a prediction that power usage data is anomalous based on detecting differences between predicted and measured power usage values in two separate month-long time periods. The anomaly prediction verification module 323 may apply different sets of rules to power usage data from different dwellings 330a-330n. A dwelling 330a with a difference of 100 kWh between predicted and measured power usage may correspond in a set of rules to a verified anomaly. A dwelling 330n with the same difference of 100 kWh between predicted and measured power usage may not correspond to an anomaly in the set of rules.

An example of a set of rules associated with a dwelling 330a may include the following:

Rule 1: An anomaly is verified in power usage data if (a) a difference between predicted and measured power usage is at least 500kWh AND (b) the time period associated with the difference corresponds to the month of Dec., Jan., Feb., or Mar., AND (c) a maximum measured power usage is at least 2,000 kWh.

Rule 2: An anomaly is verified in power usage data if (a) a difference between predicted and measured power usage is at least 800 kWh AND (b) the time period associated with the difference corresponds to the month of Apr., May, Jun., Jul., Aug., Sep., or Nov., AND (c) a maximum measured power usage is at least 1,500 kWh.

If the anomaly detection engine 322 predicts no anomaly based on the difference between the predicted power usage value generated by the machine learning model 327 and the measured power usage value for a particular period of time, the meter monitoring platform 310 transmits the power usage data to the utility billing platform 311, the forecasting platform 312, and/or the resource allocation platform 313 to perform respective operations on the power usage data.

If (a) the anomaly detection engine 322 predicts an anomaly exists in power usage data based on the difference between the predicted power usage value generated by the machine learning model 327 and the measured power usage value for a particular period of time, and (b) the anomaly prediction verification module 323 determines that the anomaly is verified, the monitoring system enhancement platform 320 initiates remedial actions to remediate faults in the system 300. The meter remediation module 324 initiates diagnostics on the power meter 333a to identify faulty components in the power meter 333a. The meter remediation module 324 may perform diagnostics to identify faulty sensors, faulty power components, faulty data transmission components, faulty memory components, or a faulty microcontroller component. The meter remediation module 324 may initiate remote repair operations on faulty components to reset components, reset stored values, and reinstall software modules. If a fault exists that cannot be repaired remotely, the meter remediation module 324 may generate a service ticket to direct a technician to diagnose and/or repair the power meter 333a.

The utility usage record management module 325 purges anomalous records from a dataset of records accessible by the utility billing platform 311, the forecasting platform 312, and the resource allocation platform 313. The utility usage record management module 325 generates a substitute record. The substitute record may include power usage values based on predicted values generated by the machine learning model 327 or based on predefined rules. For example, the utility usage record management module 325 may apply a rule to replace power usage values in an anomalous power usage record with average values based on the previous three months’ power usage values. The utility usage record management module 325 includes the substitute record in time-series data provided to the utility billing platform 311, the forecasting platform 312, and the resource allocation platform 313.

If (a) the anomaly detection engine 322 predicts an anomaly exists in power usage data based on the difference between the predicted power usage value generated by the machine learning model 327 and the measured power usage value for a particular period of time, and (b) the anomaly prediction verification module 323 determines that the anomaly is unverified, the monitoring system enhancement platform 320 initiates remedial actions. The machine learning engine 321 may generate a training record from the measured utility usage record. Whereas the machine learning model 327 predicted a utility usage value corresponding to an anomaly prediction, the machine learning engine 321 generates the training record to include a label that does not correspond to an anomaly prediction. For example, the label may specify an alternative predicted utility usage value that does not correspond to an anomalous prediction. As another example, the utility usage record management module 325 may modify a threshold in the anomaly detection engine 322 for predicting an anomaly.

According to yet another example, the monitoring system enhancement platform 320 may generate a notification to a client device 350 specifying the anomaly. Based on a user input received from the client device 350, the monitoring system enhancement platform 320 may modify the set of rules that make up the anomaly prediction verification module 323. The modification may include modifying the rules to specify the attributes of the utility usage as being verified as anomalous.

A user may interact with the monitoring system enhancement platform 320 via the interface 326. The interface 326 may present windows, fields, and content in one or more graphical user interfaces (GUIs) to allow users to generate and modify rules in the anomaly prediction verification module 323. The interface 326 may present content in the GUIs to allow users to supervise training of the machine learning model 327 by generating labels for training records. The interface 326 may present content in the GUIs to allow users to initiate diagnostic tests and remote modifications to utility meters 333a-333n.

The monitoring system enhancement platform 320 enhances the power usage monitoring system 300 by (a) verifying predicted anomalies based on predictions by a machine learning model 327, (b) remediating faults in utility meters based on verified anomalies, (c) remediating faults in a machine learning model based on determining an anomaly is unverified, (d) remediating faults in a rule-based anomaly verification model based on identifying an incorrect determination that an anomaly was unverified, and (e) remediating faults in power usage records by replacing sets of anomalous utility usage data with estimated power usage data.

### 5. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 6. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

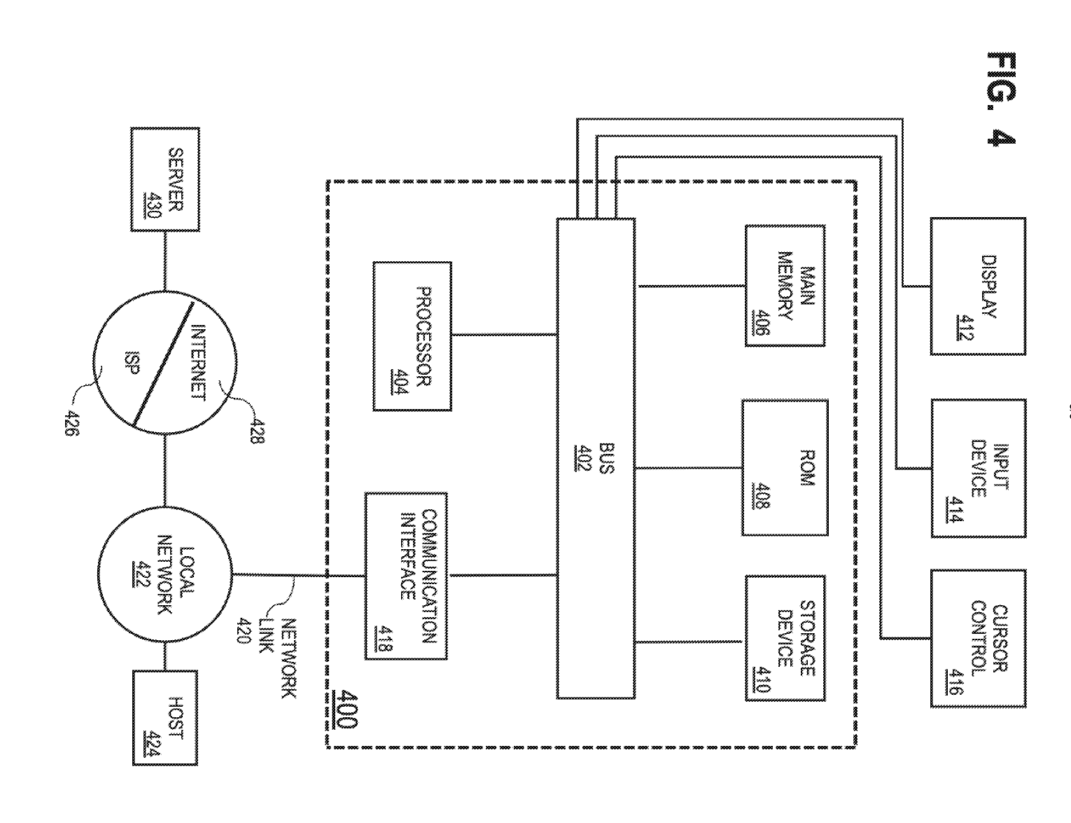

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read-only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 7. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
receiving a first set of resource-usage data from a first resource-usage monitoring device that monitors resource usage of a set of one or more resource-consuming devices;
generating a first dataset including at least the first set of resource-usage data;
inputting the first dataset to a machine learning model to generate a first anomaly prediction indicating that a first anomaly exists in relation to the first set of resource-usage data;
based on the machine learning model generating the first anomaly prediction indicating that the first anomaly exists in relation to the first set of resource-usage data, inputting the first set of resource-usage data to a rule-based model to verify whether the first anomaly prediction is accurate; and
based on the rule-based model verifying that the first anomaly prediction is accurate, initiating a first remedial operation to perform at least one of: (a) diagnose or repair the first resource-usage monitoring device or (b) modify a downstream function that utilizes the first set of resource usage data as input data.

2. The one or more non-transitory computer readable media of claim 1, wherein generating the first dataset includes generating a set of time-series data that includes the first set of resource-usage data corresponding to a first period of time and at least one additional set of resource-usage data generated by the first resource-usage monitoring device corresponding to a second period of time.

3. The one or more non-transitory computer readable media of claim 1, wherein generating the first dataset includes generating a set of comparison data that includes the first set of resource-usage data corresponding to a first period of time and at least one additional set of resource-usage data generated by at least one additional monitoring device corresponding to the first period of time.

4. The one or more non-transitory computer readable media of claim 1, wherein the first anomaly prediction includes a score, and
wherein applying the rule-based model to the first set of resource-usage data is performed based on determining the score exceeds a threshold.

5. The one or more non-transitory computer readable media of claim 1, wherein the operations further comprise:
based on determining the first anomaly prediction is accurate, initiating a first remedial operation to diagnose and repair the first resource-usage monitoring device.

6. The one or more non-transitory computer readable media of claim 5, wherein the operations further comprise:
receiving a second set of resource-usage data from a second resource-usage monitoring device that monitors resource usage of the set of one or more resource-consuming devices, wherein the second resource-usage monitoring device comprises at least one of:
a replacement of the first resource-usage monitoring device; and
the first resource-usage monitoring device including one or more replaced or repaired components;
generating a second dataset including at least the second set of resource-usage data;
applying the machine learning model to the second dataset to generate a second anomaly prediction corresponding to whether an anomaly exists based at least on the second set of resource-usage data; and
based on determining the machine learning model predicts no anomaly exists based at least on the second set of resource-usage data, initiating a downstream function using the second set of resource-usage data as input data to the downstream function.

7. The one or more non-transitory computer readable media of claim 1, wherein the operations further comprise:
based on determining the first anomaly prediction is accurate, initiating the first remedial operation to modify the downstream function that utilizes the first set of resource-usage data as input data at least by omitting the first set of resource-usage data from a set of input data provided to the downstream function,
wherein the downstream function includes at least one of a billing function, a resource-usage prognostication function, and a resource allocation planning function.

8. The one or more non-transitory computer readable media of claim 1, wherein the first resource-usage monitoring device is a utility meter, and
wherein the first dataset includes at least the first set of resource-usage data and a set of weather data for a location corresponding to the utility meter.

9. The one or more non-transitory computer readable media of claim 1, wherein the machine learning model is a deep learning long short-term memory (LSTM) type model.

10. The one or more non-transitory computer readable media of claim 1, wherein the operations further comprise:
presenting a graphical user interface (GUI) including a visualization of at least one of the first anomaly prediction by the machine learning model and a verification result generated by the rule-based model.

11. The one or more non-transitory computer readable media of claim 1, wherein the operations comprise:
inputting a second dataset to the machine learning model to generate a second anomaly prediction corresponding to whether a second anomaly exists based at least on a second set of resource-usage data;
based on determining the machine learning model predicts the second anomaly exists, inputting the second set of resource-usage data to the rule-based model to verify whether the second anomaly prediction is accurate; and
based on determining the second anomaly prediction is inaccurate, initiating a second remedial operation to retrain the machine learning model with training data including at least one training record based on the second anomaly prediction and the second set of resource-usage data.

12. A method comprising:
receiving a first set of resource-usage data from a first resource-usage monitoring device that monitors resource usage of a set of one or more resource-consuming devices;
generating a first dataset including at least the first set of resource-usage data;
inputting the first dataset to a machine learning model to generate a first anomaly prediction indicating that a first anomaly exists in relation to the first set of resource-usage data;
based on the machine learning model generating the first anomaly prediction indicating that the first anomaly exists in relation to the first set of resource-usage data, inputting the first set of resource-usage data to a rule-based model to verify whether the first anomaly prediction is accurate; and
based on the rule-based model verifying that the first anomaly prediction is accurate, initiating a first remedial operation to perform at least one of: (a) diagnose or repair the first resource-usage monitoring device or (b) modify a downstream function that utilizes the first set of resource usage data as input data,
wherein the method is performed by at least one device including a hardware processor.

13. The method of claim 12, wherein generating the first dataset includes generating a set of time-series data that includes the first set of resource-usage data corresponding to a first period of time and at least one additional set of resource-usage data generated by the first resource-usage monitoring device corresponding to a second period of time.

14. The method of claim 12, wherein generating the first dataset includes generating a set of comparison data that includes the first set of resource-usage data corresponding to a first period of time and at least one additional set of resource-usage data generated by at least one additional monitoring device corresponding to the first period of time.

15. The method of claim 12, wherein the first anomaly prediction includes a score, and
wherein applying the rule-based model to the first set of resource-usage data is performed based on determining the score exceeds a threshold.

16. The method of claim 12, further comprising:
based on determining the first anomaly prediction is accurate, initiating a first remedial operation to diagnose and repair the first resource-usage monitoring device.

17. The method of claim 16, further comprising:
receiving a second set of resource-usage data from a second resource-usage monitoring device that monitors resource usage of the set of one or more resource-consuming devices, wherein the second resource-usage monitoring device comprises at least one of:
a replacement of the first resource-usage monitoring device; and
the first resource-usage monitoring device including one or more replaced or repaired components;
generating a second dataset including at least the second set of resource-usage data;
applying the machine learning model to the second dataset to generate a second anomaly prediction corresponding to whether an anomaly exists based at least on the second set of resource-usage data; and
based on determining the machine learning model predicts no anomaly exists based at least on the second set of resource-usage data, initiating a downstream function using the second set of resource-usage data as input data to the downstream function.

18. The method of claim 12, further comprising:
based on determining the first anomaly prediction is accurate, initiating the first remedial operation to modify the downstream function that utilizes the first set of resource-usage data as input data at least by omitting the first set of resource-usage data from a set of input data provided to the downstream function,
wherein the downstream function includes at least one of a billing function, a resource-usage prognostication function, and a resource allocation planning function.

19. The method of claim 12, wherein the first resource-usage monitoring device is a utility meter, and
wherein the first dataset includes at least the first set of resource-usage data and a set of weather data for a location corresponding to the utility meter.

20. A system comprising:
at least one device including a hardware processor;
the system being configured to perform operations comprising:
receiving a first set of resource-usage data from a first resource-usage monitoring device that monitors resource usage of a set of one or more resource-consuming devices;
generating a first dataset including at least the first set of resource-usage data;
inputting the first dataset to a machine learning model to generate a first anomaly prediction indicating that a first anomaly exists in relation to the first set of resource-usage data;
based on the machine learning model generating the first anomaly prediction indicating that the first anomaly exists in relation to the first set of resource-usage data, inputting the first set of resource-usage data to a rule-based model to verify whether the first anomaly prediction is accurate; and
based on the rule-based model verifying that the first anomaly prediction is accurate, initiating a first remedial operation to perform at least one of: (a) diagnose or repair the first resource-usage monitoring device or (b) modify a downstream function that utilizes the first set of resource usage data as input data.
